(19) United States
(12) Patent Application Publication
(10) Pub. No.: US 2026/0356088 A1
(43) Pub. Date: Nov. 12, 2026

(54) LAMINATION PROCESSING APPARATUS, IMAGE FORMING SYSTEM, AND LAMINATION PROCESSING METHOD

(71) Applicant: Konica Minolta, Inc., Tokyo (JP)

(72) Inventor: Naoshi KASHIWAGURA, Tokyo (JP)

(21) Appl. No.: 19/661,153

(22) Filed: Apr. 28, 2026

(30) Foreign Application Priority Data
May 7, 2025 (JP) 2025-077345

(51) Int. Cl. B32B 41/00; B32B 38/00; B32B 43/00

(52) U.S. Cl. CPC B32B 41/00; B32B 38/0004; B32B 38/0012; B32B 43/003

(57) ABSTRACT

Provided is a lamination processing apparatus that includes a lamination processor that forms a laminated product by performing lamination at a stage prior to a folding processing apparatus that performs folding processing. The lamination processor performs the lamination by covering all of a predetermined number, which is equal to or greater than two, of recording materials with a common laminate sheet from a front side and with another common laminate sheet from a back side, where the predetermined number of recording materials are arranged side by side such that the recording materials are not present in a portion in which the folding processing is performed.

### CROSS REFERENCE TO RELATED APPLICATIONS

Japanese Patent Application No. 2025-077345 filed on May 7, 2025, including description, claims, drawings, and abstract the entire disclosure is incorporated herein by reference in its entirety.

### BACKGROUND

### Technological Field

The present invention relates to a lamination processing apparatus, an image forming system, and a lamination processing method.

### Description of Related Art

There is known a technology of protecting a recording material by performing lamination on the recording material after image formation. In the lamination, for example, laminate sheets are disposed at the front and back of the recording material, and the disposed sheets are pressurized and heated by a pressure bonding roller pair to pressure-bond the recording material and the laminate sheets. Thus, a laminated product is formed.

Incidentally, there is a problem in that it is difficult to perform folding processing on a laminate sheet after lamination. This is because when the folding processing is performed, a laminate sheet located on the side of the inner surface of the folded portion is peeled off from the recording material, and bending or wrinkling may occur.

For example, Japanese Patent Publication Laid-Open No. 2023-96796 proposes that a region in a folded portion, where the region is affected by folding processing, is set as a region on which lamination is not executed, and that lamination is performed on only a region that is not affected by the folding processing (see FIG. 15 of Japanese Patent Publication Laid-Open No. 2023-96796).

### SUMMARY

In the technology described in Japanese Patent Publication Laid-Open No. 2023-96796, cutting of a laminate sheet is executed before lamination. Since the leading edge of the cut laminate sheet is likely to be curled, the lamination position is likely to vary. Due to the influence of such misalignment of a laminate sheet, a defective product may be generated among laminated products. In addition, in a folded portion of a laminated product, a recording material is not coated with a laminate sheet, and thus, there is a concern that the durability of the laminated product may be reduced.

An object of the present invention is to improve the yield of a laminated product by suppressing bending or peeling of a laminate sheet in a folded portion.

An aspect of a lamination processing apparatus of the present invention comprises a lamination processor that forms a laminated product by performing lamination at a stage prior to a folding processing apparatus that performs folding processing.

The lamination processor performs the lamination by covering all of a predetermined number, which is equal to or greater than two, of recording materials with a common laminate sheet from a front side and with another common laminate sheet from a back side, where the predetermined number of recording materials are arranged side by side such that the recording materials are not present in a portion in which the folding processing is performed.

An aspect of an image forming system of the present invention comprises: an image forming apparatus that forms an image on a recording material; and the lamination processing apparatus that is disposed at a stage subsequent to the image forming apparatus.

An aspect of a lamination processing method of the present invention comprises a lamination processing step of forming a laminated product by performing lamination at a stage prior to a folding processing apparatus that performs folding processing.

In the lamination processing step, the lamination is performed by covering all of a predetermined number, which is equal to or greater than two, of recording materials with a common laminate sheet from a front side and with another common laminate sheet from a back side, where the predetermined number of recording materials are arranged side by side such that the recording materials are not present in a portion in which the folding processing is performed.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIGS. 1A and 1B are plan views provided for describing an example of a laminated product obtained by a lamination processing apparatus of the present invention, and FIG. 1C is a cross-sectional view of the laminated product taken along line A-A;

FIG. 2 is a plan view of a laminated product;

FIGS. 3A and 3B are plan views of laminated products on which folding processing has been performed;

FIG. 4 is a diagram illustrating a schematic configuration of the lamination processing apparatus;

FIG. 5 is a block diagram illustrating the configuration of the lamination processing apparatus;

FIGS. 6A and 6B are diagrams illustrating an example of an operation display section;

FIG. 7 is a diagram illustrating operations of the lamination processing apparatus;

FIG. 8 is a diagram illustrating operations of the lamination processing apparatus;

FIG. 9A is a diagram illustrating an example of a schematic configuration of an image forming system, and FIG. 9B is a diagram illustrating another example of the schematic configuration of the image forming system;

FIG. 10A is a diagram illustrating a first half of a flowchart illustrating a lamination processing method; and

FIG. 10B is a diagram illustrating a second half of the flowchart illustrating the lamination processing method.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment according to the present invention will be described in detail with reference to the accompanying drawings. In the present specification and drawings, constituent elements which are substantially the same are denoted by the same reference signs and duplicate descriptions thereof will be omitted.

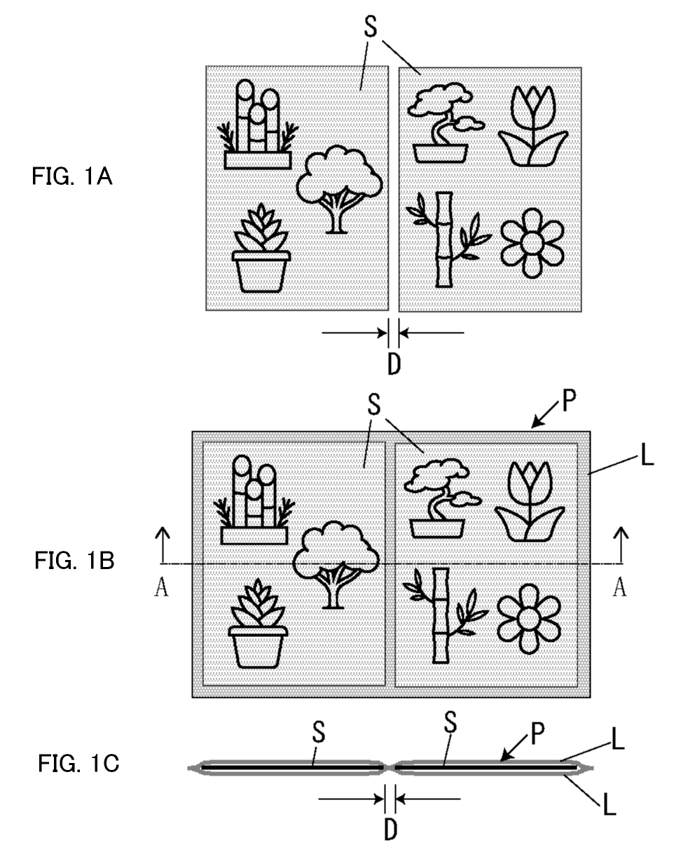

In the present embodiment, in a lamination processing apparatus 1 to be described later, a predetermined number, which is equal to or greater than two, of recording materials (sheets) S are arranged side by side with a gap D of a predetermined size as illustrated in FIG. 1A. Further, as illustrated in FIGS. 1B and 1C, the predetermined number, which is equal to or greater than two, of recording materials (sheets) S are covered with one common laminate sheet L from the front side and with one common laminate sheet L from the back side. In this state, lamination is performed. For example, an image to be formed on an A3 size sheet is separately printed on two A4 size sheets, and the two A4 size sheets are laminated in a state of being arranged side by side with a gap therebetween, whereby a laminated product P substantially similar to a laminated product obtained by laminating one A3 size sheet can be obtained.

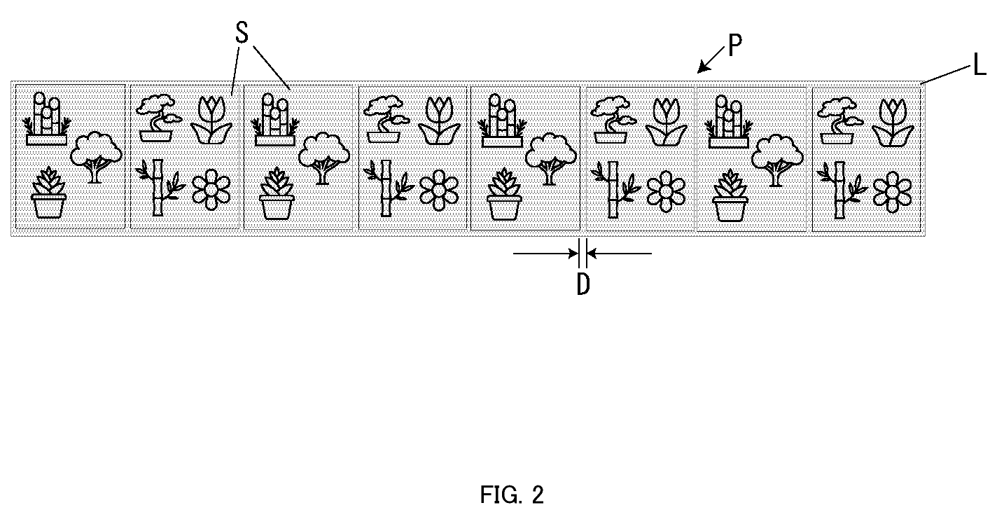

FIG. 2 illustrates a laminated product formed by using one laminate sheet L at the front and one laminate sheet L at the back, respectively, in a state in which eight recording materials S are arranged side by side with a gap D of a predetermined size. In this case, a laminated material P longer than the recording material S having a length that can be handled by a general image forming apparatus can be produced. Note that, the gap D does not necessarily have to be provided, and lamination may be performed by using one laminate sheet L at the front and one laminate sheet L at the back in a state in which two consecutive recording materials S are arranged side by side without a gap.

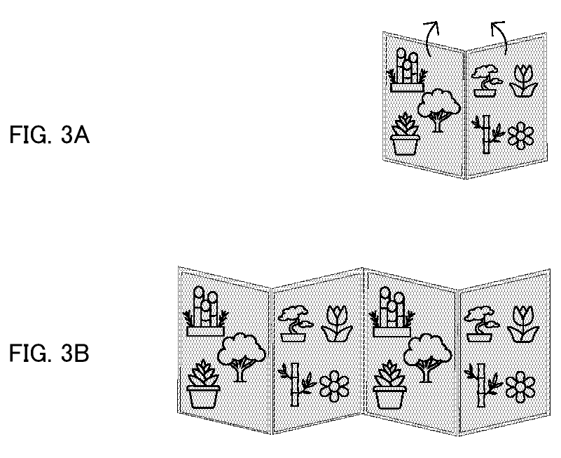

In addition, as illustrated in FIGS. 3A and 3B, a gusset can also be formed by performing folding processing on the gap D. This case has an advantage that the folding processing can be easily performed since no recording material S is present in the folded portion.

### Configuration of Lamination Processing Apparatus

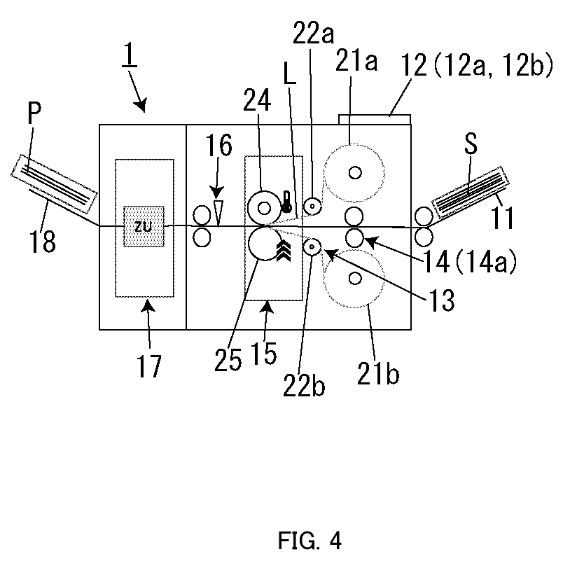

FIG. 4 is a diagram illustrating a schematic configuration of the lamination processing apparatus 1.

The lamination processing apparatus 1 produces a laminated product P by coating the recording material S, on which an image has been formed, with the laminate sheet L. In the present embodiment, the lamination processing apparatus 1 includes a supply tray 11, an operation display section 12, a laminate sheet conveyance section 13, a recording material conveyor 14, a lamination processor 15, a cutter 16, a folding processing apparatus 17, and an ejection tray 18. Note that, the main part of the lamination processing apparatus 1 includes a part disposed at a stage prior to the folding processing apparatus 17. Accordingly, the lamination processing apparatus 1 may be regarded as including the supply tray 11, the operation display section 12, the laminate sheet conveyance section 13, the recording material conveyor 14, the lamination processor 15, and the cutter 16.

The supply tray 11 has a plate shape on which one or a plurality of recording materials S can be placed. The supply tray 11 supplies the recording material S to the recording material conveyor 14. An image has been formed on the recording material S by an image forming apparatus (not illustrated). Note that, as will be described later, the recording material S may also be supplied from an image forming apparatus 100 to the lamination processing apparatus 1. In this case, the lamination processing apparatus 1 may not include the supply tray 11.

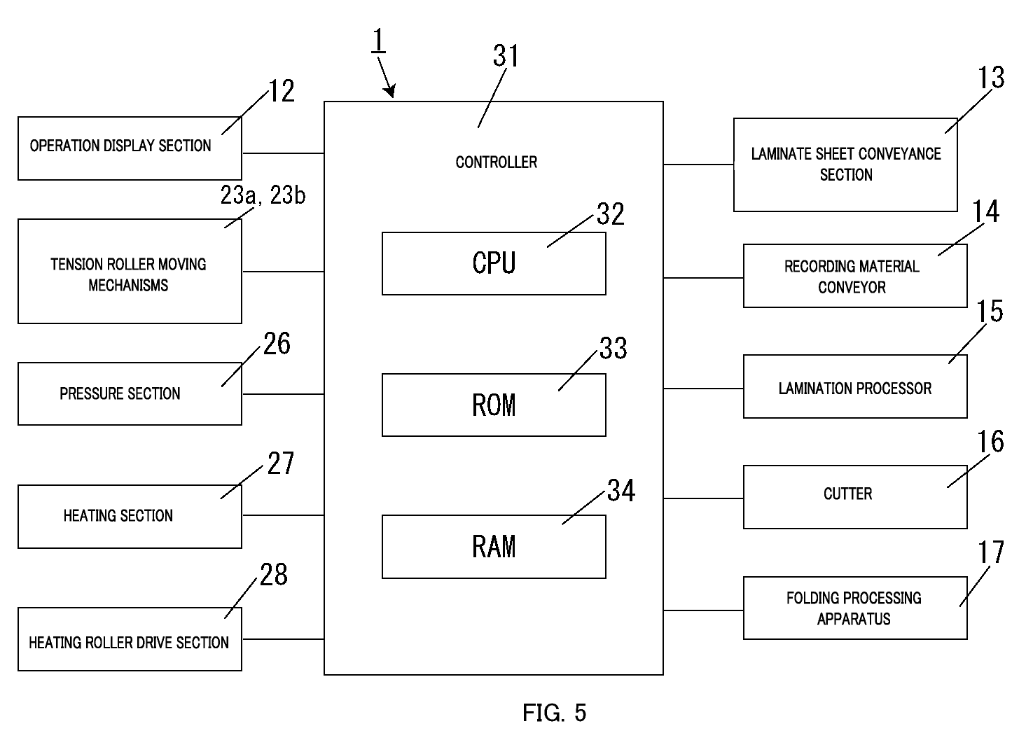

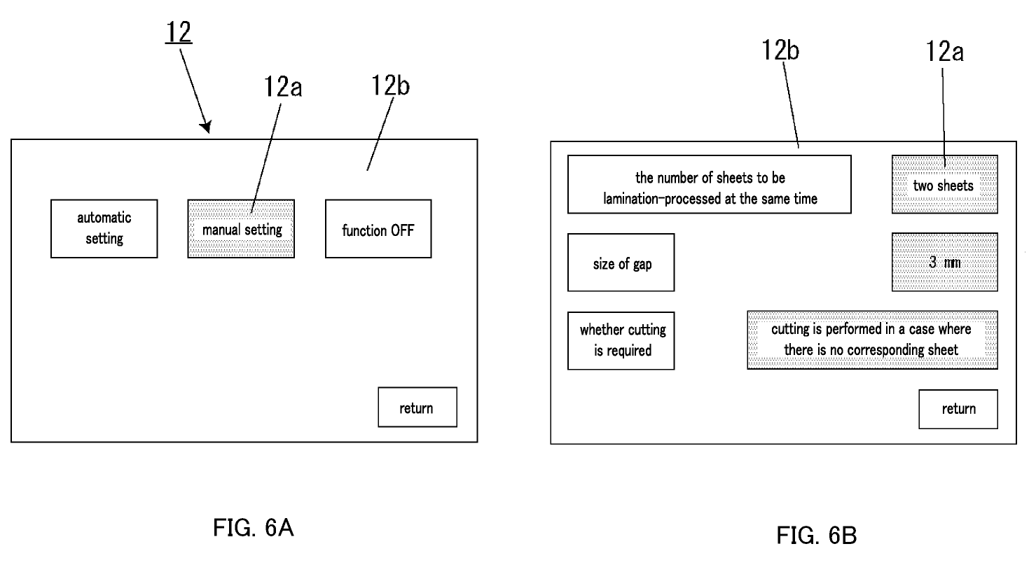

The operation display section 12 includes an operation section 12a and a display section 12b as illustrated in FIGS. 6A and 6B. The display section 12b is, for example, a display apparatus such as a liquid crystal display (LCD). The display section 12b displays various screens according to display control signals inputted from a controller 31 (see FIG. 5) of the lamination processing apparatus 1. The operation section 12a may be a touch screen disposed so as to cover the display screen of the display section 12b, and includes various operation buttons such as numeric buttons and a start button on the display screen. The operation section 12a receives an operation instruction from the user. The operation section 12a outputs an operation signal based on a user’s operation to the controller 31.

The user can set the number of recording materials S (for example, two recording materials in the case of FIGS. 1A-1C and eight recording materials in the case of FIG. 2) constituting one laminated product P at the operation section 12a. As illustrated in FIGS. 1B, 3A, and 3B, the user can also perform a setting at the operation section 12a such that an image to be formed on an A3 size sheet is printed on two A4 size sheets separately. In addition, the user can also set the size of the gap between two consecutive recording materials S at the operation section 12a.

Inside the lamination processing apparatus 1, laminate sheet rolls 21a and 21b around which the laminate sheet L is wound in a roll shape are disposed. The laminate sheet L is obtained by forming a transparent or translucent resin such as polyester, polypropylene, or polyethylene terephthalate into a sheet shape. The laminate sheet conveyance section 13 includes a pull-out roller (not illustrated), a plurality of conveyance rollers (not illustrated), and tension rollers 22a and 22b.

The pull-out roller of the laminate sheet conveyance section 13 pulls out the laminate sheet L from the laminate sheet rolls 21a and 21b. The plurality of conveyance rollers of the laminate sheet conveyance section 13 conveys the laminate sheet L pulled out by the pull-out roller to the lamination processor 15. In addition, the plurality of conveyance rollers of the laminate sheet conveyance section 13 sends the recording material S laminated by the lamination processor 15 to the cutter 16.

The tension rollers 22a and 22b are disposed on the upstream side of the lamination processor 15. The laminate sheet L pulled out from the laminate sheet roll 21a is wound around the tension roller 22a. The laminate sheet L pulled out from the laminate sheet roll 21a is disposed to face one recording surface of the recording material S in the lamination processor 15. The laminate sheet L pulled out from the laminate sheet roll 21b is wound around the tension roller 22b. The laminate sheet L pulled out from the laminate sheet roll 21b is disposed to face the other recording surface of the recording material S in the lamination processor 15.

The rotation shafts of the tension rollers 22a and 22b are held by tension roller moving mechanisms 23a and 23b (see FIG. 5). The tension roller moving mechanisms 23a and 23b move the positions of the rotation shafts of the tension rollers 22a and 22b. Thus, the tension rollers 22a and 22b approach and are separated from the lamination processor 15. As a result, the tension rollers 22a and 22b can change the tension of the laminate sheet L that is conveyed to the lamination processor 15.

The recording material conveyor 14 includes a plurality of conveyance rollers including a registration roller 14a. The plurality of conveyance rollers of the recording material conveyor 14 conveys the recording material S, which has been supplied from the supply tray 11, to the lamination processor 15.

The lamination processor 15 includes a heating roller 24, a pressure roller 25, as well as a pressure section 26 and a heating section 27 both of which are illustrated in FIG. 5. The heating roller 24 is rotated and driven in a processing conveyance direction in which the recording material S and the laminate sheet L are conveyed together. The processing conveyance direction is a direction in which the recording material S and the laminate sheet L approach the cutter 16. The pressure roller 25 is, in a pressurized state, in contact with the heating roller 24. In addition, the pressure roller 25 rotates following the rotation of the heating roller 24.

The pressure section 26 presses the pressure roller 25 to the side of the heating roller 24. The pressure section 26 includes a holding mechanism that holds both end portions of the rotation shaft of the pressure roller 25, and a bias mechanism that biases the holding mechanism in a direction in which the holding mechanism is separated from the heating roller 24. The holding mechanism causes the pressure roller 25 to approach and be separated from the heating roller 24. The heating section 27 heats the heating roller 24. The heating section 27 includes a heater disposed at the rotation shaft of the heating roller 24.

The heating roller 24 and the pressure roller 25 of the lamination processing section 15 heat and pressurize the laminate sheet L while conveying the recording material S and the laminate sheet L. Thus, the laminate sheets L stacked on the both surfaces of the recording material S are pressure-bonded, and the recording material S is coated with the laminate sheets L.

The cutter 16 is disposed on the downstream side of the lamination processor 15. The cutter 16 cuts an end portion of the laminate sheet L with which the recording material S has been coated. The cut laminate sheet L is sent to the folding processing apparatus 17 by the plurality of conveyance rollers of the laminate sheet conveyance section 13.

Since the inner configuration of the folding processing apparatus 17 is well known, detailed description thereof will be omitted. The laminate sheet L cut by the cutter 16 is subjected to folding processing by the folding processing apparatus 17 as necessary to become a laminated product P, and is sent to the ejection tray 18. The ejection tray 18 is formed in a plate shape on which one or a plurality of laminated products P can be placed.

### Example of Configuration of Control System of Lamination Processing Apparatus

Next, an example of the configuration of the control system of the lamination processing apparatus 1 will be described with reference to FIG. 5.

The lamination processing apparatus 1 includes the controller 31. The controller 31 is constituted by, for example, a central processing unit (CPU) 32, a read only memory (ROM) 33, a random access memory (RAM) 34, and the like. The CPU 32 reads various programs stored in the ROM 33 and loads the read programs into the RAM 34. Then, the CPU 32 controls the operation of each section of the lamination processing apparatus 1 according to the loaded programs.

The ROM 33 stores various processing programs for controlling each section of the lamination processing apparatus 1, parameters and table data necessary for executing the programs, various files, and the like. The ROM 33 stores, for example, a laminate control table in which physical property information of the recording material S is associated with a control amount (control parameter) of each section of the lamination processing apparatus 1. The CPU 32 determines the control amount of each section such as the pressure section 26 and the heating section 27 of the lamination processor 15 based on the laminate control table and/or the input information from the user.

The RAM 34 is constituted by, for example, a volatile semiconductor memory. The RAM 34 forms a work area for temporarily storing various processing programs read from the ROM 33, input data or output data, parameters, and the like in various pieces of processing executed by the CPU 32.

The operation display section 12, the tension roller moving mechanisms 23a and 23b, the pressure section 26, the heating section 27, a heating roller drive section 28, the cutter 16, the folding processing apparatus 17, and the like are electrically connected to the controller 31. In addition, drive sections (illustration is omitted) for the plurality of conveyance rollers in the laminate sheet conveyance section 13 and the recording material conveyor 14 are electrically connected to the controller 31.

The operation display section 12 displays various screens according to control signals supplied from the controller 31. Exemplary display screens of the operation display section 12 are illustrated in FIGS. 6A and 6B.

The recording material conveyor 14 changes the rotational speed of the registration roller 14a according to a drive signal supplied from the controller 31, and performs adjustment such that the gap D formed between two sheets that are continuously conveyed has a predetermined size (a value set in advance or a value inputted by the user). It may also be configured such that the size of the gap is changed between a case where the folding processing is performed on the gap D and a case where cutting is performed. That is, the size of the gap D as the folding processing gap and the size of the gap D as the cutting gap can be caused to be different from each other.

Here, there is a case where the folding processing is integrally performed in a state in which a plurality of laminate sheets L after the lamination processing is stacked. In such a case, the size of the gap D (folding processing gap) in a portion serving as a gusset of the folding processing may also be changed according to the number of laminate sheets L to be stacked. In particular, as the number of laminated products P to be stacked increases, the size of the gap D in the portion serving as the gusset is preferably increased.

The tension roller moving mechanism 23a and 23b change the positions of the tension rollers 22a and 22b according to drive signals supplied from the controller 31.

The pressure section 26 causes the pressure roller 25 to approach and be separated from the heating roller 24 according to a drive signal supplied from the controller 31. Thus, the pressure applied to the laminate sheet L passing between the pressure roller 25 and the heating roller 24 changes.

The heating section 27 adjusts the output of the heater according to a drive signal supplied from the controller 31. Thus, the temperature of the heating roller 24 changes, and the amount of heat applied to the laminate sheet L passing between the pressure roller 25 and the heating roller 24 changes.

The heating roller drive section 28 adjusts the rotational speed of the heating roller 24 according to a drive signal supplied from the controller 31. Thus, the conveyance speed of the laminate sheet L and the recording material S in the lamination processing section 15 changes.

The cutter 16 cuts an end portion of the laminate sheet L, with which the recording material S has been coated, according to a drive signal supplied from the controller 31. Specifically, the cutter 16 is set to perform cutting processing at a timing when a predetermined number of laminated recording materials S have passed through the lamination processor 15.

In a case where the folding processing is performed on the gap of the laminated product P to form the gusset, the cutter 16 cuts the gap other than the portion serving as the gusset.

The folding processing apparatus 17 performs the folding processing on the laminate sheet L supplied from the lamination processing apparatus 1 as necessary according to a drive signal supplied from the controller 31 to form a laminated product P. The laminated product P is sent from the folding processing apparatus 17 to the ejection tray 18.

Next, an example of the control by the controller 31 when the folding processing is performed will be described.

The controller 31 receives job inputs of the lamination processing and the folding processing from the user via the operation section 12a. For example, when the user selects “manual setting” in the screen display of FIG. 6A, the screen display changes to that as illustrated in FIG. 6B. Then, when the user selects to laminate two A4 size sheets arranged side by side with the gap D therebetween instead of laminating one A3 size sheet, two A4 size sheets are fed from the sheet feed tray according to the instruction of the controller 31 that has received the job inputs. As illustrated in FIG. 6B, the user can input the dimensions of the gap D, and further in a case where there is no corresponding sheet, the user can select, by pull-down, whether cutting is performed.

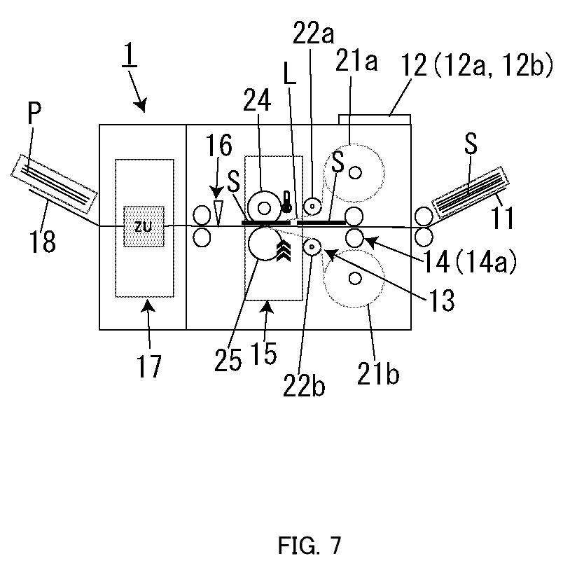

Next, the controller 31 controls the registration roller 14a of the recording material conveyor 14 so that the two A4 size sheets are fed out to the lamination processor 15 in a state in which a gap of a predetermined size corresponding to the size for the gusset width in the folding processing is provided between the two A4 size sheets as illustrated in FIG. 7.

The lamination processor 15 performs lamination processing while maintaining the gusset width of the predetermined size, and sends a laminated product thus formed (intermediate product) to the cutter 16.

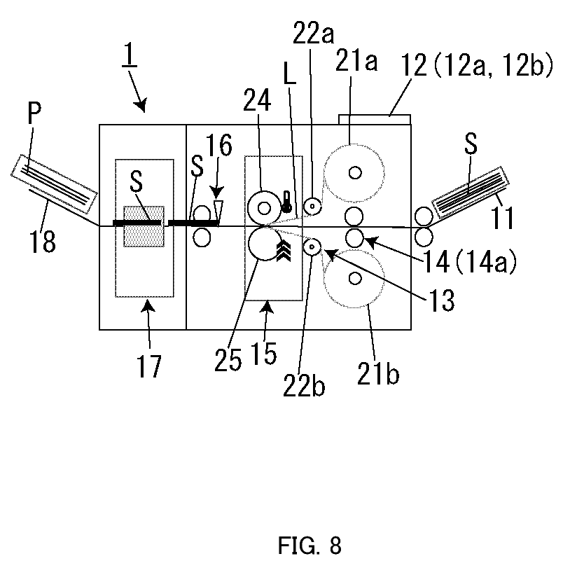

At the cutter 16, cutting is performed at a predetermined timing when the two A4 size sheets laminated as illustrated in FIG. 8 have passed through the lamination processor 15. The cut intermediate product is sent to the folding processing apparatus 17.

The folding processing apparatus 17 forms a gusset by performing folding processing on the gap between the two A4 size sheets, thereby forming a laminated product P (finished product). In a case where the folding processing is integrally performed in a state in which a plurality of laminate sheets L is stacked, the gusset width increases according to the number of sheets to be stacked, and thus, it is necessary to increase the size of the gap D of the portion in which the gusset is formed, according to the number of sheets to be stacked. The controller 31 may determine the appropriate size of the gap.

### Configuration of Image Forming System

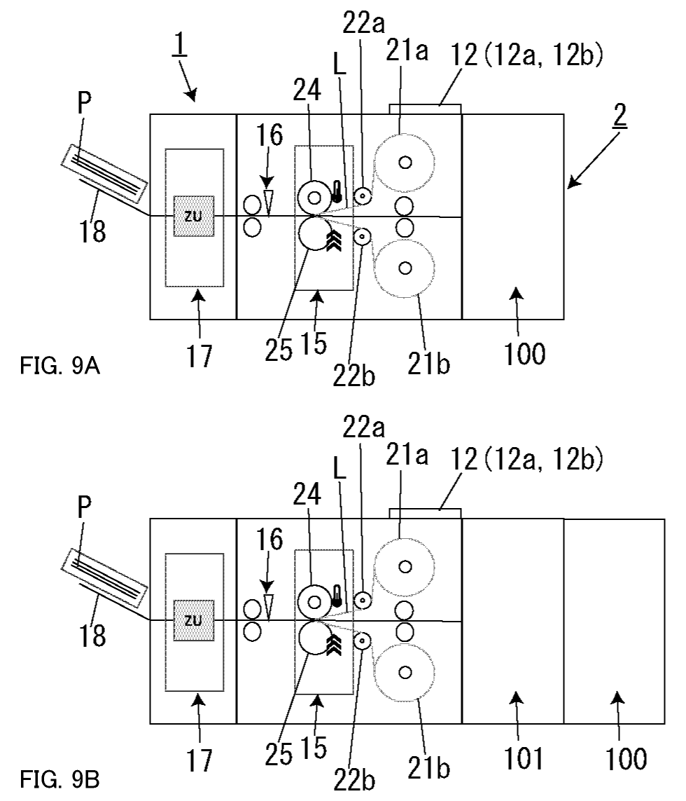

FIG. 9A is a diagram illustrating a schematic configuration of an image forming system 2.

The image forming system 2 includes the image forming apparatus 100 on the upstream side of the lamination processing apparatus 1 described above. Since the configuration of the image forming apparatus 100 is well known, detailed description thereof will be omitted. The recording material S on which an image has been drawn at the image forming apparatus 100 is supplied to the lamination processing apparatus 1.

Note that, as illustrated in FIG. 9B, a recording material cutting apparatus 101 may be disposed between the image forming apparatus 100 and the lamination processing apparatus 1. In this case, the recording material S on which an image has been drawn at the image forming apparatus 100 can be cut at the recording material cutting apparatus 101 and then lamination processing can be performed. For example, an image can be drawn on an A3 size sheet at the image forming apparatus 100, the sheet can be cut into two A4 size sheets at the recording material cutting apparatus 101, and the two A4 size sheets can be laminated in a state of being arranged side by side with the gap D therebetween as described above.

### Lamination Processing

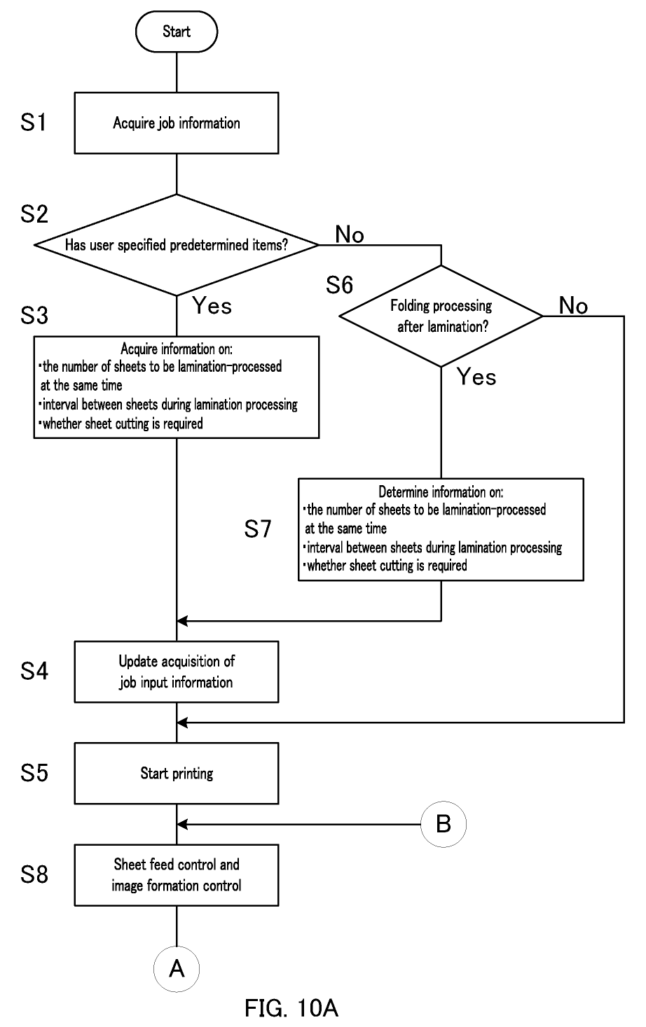

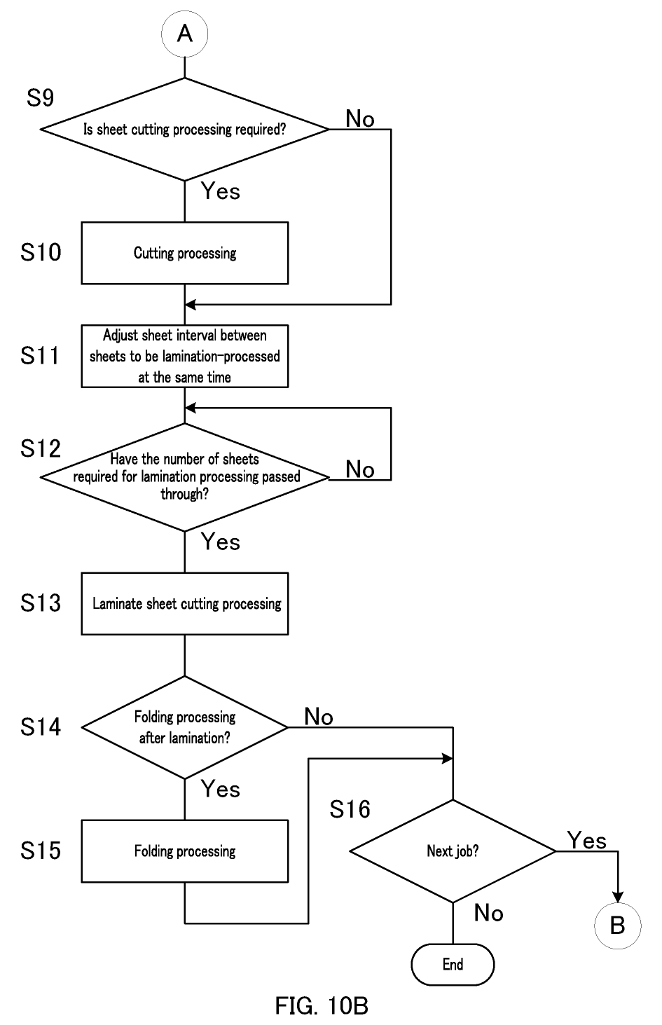

Next, a lamination processing method that is executed by the image forming system 2 will be described with reference to FIGS. 10A and 10B. Note that, in the following description, the controller 31 of the lamination processing apparatus 1 is capable of controlling the image forming system 2 in its entirety including the image forming apparatus 100, but the control of the image forming apparatus 100 may also be executed by another controller.

The controller 31 acquires job information (step S1). In a case where the user has specified, via the operation section 12a, “the number of sheets to be lamination-processed at the same time” and “the size of the gap D between sheets (recording materials S) during lamination processing” (Yes in step S2), the controller 31 acquires information on the above (step S3). In step S3, the controller 31 also acquires information on “whether cutting is performed in a case where there is no corresponding sheet”. Note that, the case of Yes in step S2 is a case where the user selects the “manual setting” in FIG. 6A and there is an input of each item in FIG. 6B. After step S3, the processing flow proceeds to step S4.

Here, an example of processing in a case where the user has selected the “manual setting” will be described in detail. In a case where a job of lamination-processing an A3 size sheet and folding the A3 size sheet in half is inputted, the controller 31 determines that a half-fold has been specified, and determines that the number of sheets to be lamination-processed at the same time is two. Next, the controller 31 determines that printing is performed on two A4 size sheets which, when the two A4 size sheets are combined, are equal to an A3 size sheet having the inputted image size.

Note that, the size of the gap D between the two sheets during lamination processing may be the size for the width of the folding position inputted by the user. Alternatively, the size of the gap D between the two sheets may have a fixed value such as 3 mm.

In addition, in a case where a plurality of sheets is stacked and folded at the same time, the interval between two sheets during lamination processing may be the size for the folding width determined from the number of sheets. However, the total length of the sheet sizes of the two sheets and the size of the gap D needs to be equal to or less than the size of the laminate sheet L. For example, in a case where the size of the long side of the laminate sheet L is 440 mm, the length of the short side of one A4 size sheet is 210 mm and 440 mm - (210 mm × 2) = 20 mm, and thus, the size of the gap D between the two sheets may be equal to or smaller than 20 mm.

Regarding whether sheet cutting is required, in a case where there are sheets having a sheet size (A4), in which two of the sheets when combined are equal to the inputted image size (A3), in a sheet feed tray, cutting processing is not performed. On the other hand, in a case where there are no sheets having a sheet size (A4) in a sheet feed tray, control is performed such that (i) an A3 size image is printed on an A3 size sheet and the A3 size sheet is then cut into two A4 size sheets at a stage subsequent thereto or (ii) cutting is not performed (similar to function OFF). A mechanism in which (I) is basically adopted and (ii) can be adopted when particularly specified by the user is preferred.

Then, the controller 31 updates the acquisition of the job input information in step S4, and causes the image forming apparatus 100 to start printing (step S5).

Incidentally, in the case of No in step S2, that is, in a case where the user selects “automatic setting” in FIG. 6A, the controller 31 determines whether folding processing is performed after the lamination processing (step S6). In the case of No in step S6, the processing flow proceeds to step S5 and printing is started. In the case of Yes in step S6, the controller 31 determines “the number of sheets to be lamination-processed at the same time”, “the size of the gap D between sheets during lamination processing”, and “whether cutting is performed in a case where cutting there is no corresponding sheet” (step S7), and proceeds to step S4.

Here, an example of processing in a case where the user has selected the “automatic setting” will be described in detail. In this case, the controller 31 determines the number of times of folding processing after lamination. For example, in the case of a half-fold as illustrated in FIG. 3A, the number of times of folding processing is one, and in the case of a tri-fold as illustrated in FIG. 3B, the number of times of folding processing is two. Next, the controller 31 determines the number of sheets to be lamination-processed at the same time according to the number of times of folding processing. For example, when the number of times of folding processing is one, the controller 31 can determine that the number of sheets to be lamination-processed at the same time is two, and when the number of times of folding processing is two, the controller 31 can determine that the number of sheets to be lamination-processed at the same time is three. Note that, the term “lamination-processing at the same time” used in the present embodiment means covering with a common laminate sheet.

In step S8, the controller 31 performs sheet feed control and image formation control. In a case where sheet cutting processing is required at the recording material cutting apparatus 101 (Yes in step S9), the recording material cutting apparatus 101 performs cutting processing (step S10), and the processing flow proceeds to step S11. In a case where sheet cutting processing is not required at the recording material cutting apparatus 101 (No in step S9), the processing flow proceeds to step S11 without performing cutting processing.

In step S11, the controller 31 adjusts the gap D between sheets to be lamination-processed at the same time. The cutter 16 waits in step S12 until sheets for the number of sheets to be lamination-processed at the same time have passed through the lamination processor 15, and when the sheets for the above number of sheets have passed therethrough (Yes in step S12), the cutter 16 cuts the laminate sheet L (step S13).

In step S14, the controller 31 determines whether there is folding processing after the lamination. In a case where there is folding processing (Yes in step S14), the processing flow proceeds to step S16 after performing the folding processing in step S15, and in a case where there is no folding processing (No in step S14), the processing flow proceeds to step S16 without performing folding processing.

In step S16, the controller 31 determines whether there is a next job, and in a case where there is a next job (Yes in step S16), the processing flow returns to step S8, and in a case where there is no next job (No in step S16), the processing flow ends.

As described above, according to the present embodiment, the lamination processing apparatus 1 includes the lamination processor 15 that forms a laminated product by performing lamination at a stage prior to the folding processing apparatus 17 that performs folding processing. The lamination processor 15 performs the lamination by covering all of a predetermined number, which is equal to or greater than two, of recording materials, with a common laminate sheet from the front side and with a common laminate sheet from the back side, where the predetermined number of recording materials are arranged side by side such that the recording materials are not present in a portion in which the folding processing is performed.

As described above, lamination is performed with one common laminate sheet at the front and with one common laminate sheet at the back in a state in which a plurality of recording materials is arranged side by side, and thus, it is possible to obtain a long laminated product which cannot be handled by a general lamination processing apparatus. In addition, since lamination is performed in a state in which there is no recording material in the folded portion, it is possible to improve the yield of the laminated product by suppressing the bending or peeling of the laminate sheet in the folded portion as in the related art. In addition, since the folded portion of the laminated product is coated with the laminate sheet, the durability of the laminated product can be improved. Since there is in general no recording material having a higher stiffness than the laminate sheet in the folded portion of the laminated product, the folding processing can be easily performed, and it is easy to open the laminated product in a folded state by 180 degrees.

Further, according to the present embodiment, the lamination processing apparatus 1 further includes the recording material conveyor 14, which conveys the recording material in the lamination processing apparatus 1, and the controller 31. The controller 31 controls the lamination processor 15 and/or the recording material conveyor 14 such that a folding processing gap is provided in the portion.

Further, according to the present embodiment, the lamination processing apparatus 1 includes the cutter 16 that cuts the laminated product at a stage prior to the folding processing apparatus 17. The cutter 16 cuts a long laminated product for each of the predetermined number, where the long laminated product is a long laminated product in which every recording material is covered with the common laminate sheet from the front side and with the common laminate sheet from the back side and the number of the every recording material is larger than the predetermined number.

Further, according to the present embodiment, the lamination processing apparatus 1 further includes the recording material conveyor 14, which conveys the recording material in the lamination processing apparatus 1, and the controller 31. The controller 31 controls the lamination processor 15 and/or the recording material conveyor 14 such that a folding processing gap is provided in the portion and a cutting gap is provided between a plurality of the recording materials arranged side by side in a portion different from the portion.

Further, according to the present embodiment, the controller 31 causes the size of the folding processing gap and the size of the cutting gap to be different from each other.

Further, according to the present embodiment, the controller 31 changes the size of the folding processing gap according to the number of laminate sheets to be stacked. In particular, the controller 31 increases the size of the folding processing gap as the number of laminate sheets to be stacked increases.

Although embodiments of the present invention have been described and illustrated in detail, it is clearly understood that the same is by way of illustration and example only and not limitation, the scope of the present invention should be interpreted by terms of the appended claims.

What is claimed is:

1. A lamination processing apparatus, comprising a lamination processor that forms a laminated product by performing lamination at a stage prior to a folding processing apparatus that performs folding processing, wherein
the lamination processor performs the lamination by covering all of a predetermined number of recording materials with a common laminate sheet from a front side and with another common laminate sheet from a back side, the predetermined number of recording materials being arranged side by side such that the recording materials are not present in a portion in which the folding processing is performed, the predetermined number being equal to or greater than two.

2. The lamination processing apparatus according to claim 1, further comprising a recording material conveyor and a hardware processor, the recording material conveyor conveying the recording material in the lamination processing apparatus, the hardware processor functioning as a controller in the lamination processing apparatus, wherein
the controller controls the lamination processor and/or the recording material conveyor such that a folding processing gap is provided in the portion.

3. The lamination processing apparatus according to claim 1, further comprising a cutter that cuts the laminated product at a stage prior to the folding processing apparatus, wherein
the cutter cuts a long laminated product for each of the predetermined number, the long laminated product being a long laminated product in which every recording material is covered with the common laminate sheet from the front side and with the other common laminate sheet from the back side, a number of the every recording material being larger than the predetermined number.

4. The lamination processing apparatus according to claim 3, further comprising a recording material conveyor and a hardware processor, the recording material conveyor conveying the recording material in the lamination processing apparatus, the hardware processor functioning as a controller in the lamination processing apparatus, wherein
the controller controls the lamination processor and/or the recording material conveyor such that a folding processing gap is provided in the portion and a cutting gap is provided between a plurality of the recording materials arranged side by side in a portion different from the portion.

5. The lamination processing apparatus according to claim 4, wherein
the controller causes a size of the folding processing gap and a size of the cutting gap to be different from each other.

6. The lamination processing apparatus according to claim 2, wherein
the controller changes the size of the folding processing gap according to a number of a plurality of the common lamination sheets to be stacked.

7. The lamination processing apparatus according to claim 6, wherein
the controller increases the size of the folding processing gap as the number of the plurality of common laminate sheets to be stacked increases.

8. An image forming system, comprising:
an image forming apparatus that forms an image on a recording material; and
the lamination processing apparatus according to claim 1 that is disposed at a stage subsequent to the image forming apparatus.

9. A lamination processing method, comprising
a lamination processing step of forming a laminated product by performing lamination at a stage prior to a folding processing apparatus that performs folding processing, wherein
in the lamination processing step, the lamination is performed by covering all of a predetermined number of recording materials with a common laminate sheet from a front side and with another common laminate sheet from a back side, the predetermined number of recording materials being arranged side by side such that the recording materials are not present in a portion in which the folding processing is performed, the predetermined number being equal to or greater than two.
